(19) United States
(12) Patent Application Publication
(10) Pub. No.: US 2025/0200426 A1
(43) Pub. Date: Jun. 19, 2025

(54) MACHINE LEARNING-BASED SYNTHESIS RUNTIME PREDICTION METHOD

(71) Applicant: MEDIATEK INC., Hsin-Chu (TW)

(72) Inventors: I-Lun Tseng, Hsinchu City (TW); Ching-Yu Shih, Hsinchu City (TW); Jian-Wei Lin, Hsinchu City (TW); Wen-Chun Lan, Hsinchu City (TW)

(73) Assignee: MEDIATEK INC., Hsin-Chu (TW)

(21) Appl. No.: 18/540,911

(22) Filed: Dec. 15, 2023

(51) Int. Cl. G06N 5/022

(52) U.S. Cl. CPC G06N 20/00

(57) ABSTRACT

A machine learning-based synthesis runtime prediction method includes collecting initial training data from a database, selecting featured training data from the initial training data useful for predicting runtimes, building a machine learning model for predicting the runtimes based on the featured training data, measuring a loss and an accuracy of the machine learning model, performing standardization and/or normalization on the featured training data of the training data to generate updated training data if the loss and/or the accuracy fails to meet predefined criteria, performing clustering at least once on the updated training data to generate clustered training data, identifying at least one outlier from the clustered training data, removing the at least one outlier to generate filtered training data, and preprocessing, training and testing the machine learning model based on the filtered training data until the loss and the accuracy meet the predefined criteria.

### BACKGROUND

There are a lot of parameters to tune in the process of running electronic design automation (EDA) tools for front-end and back-end phases of designing integrated circuits (ICs); a front-end phase is also known as a logic synthesis phase, and a back-end phase is also known as a physical synthesis phase. Therefore, tuning the parameters for a large design space and meeting physical implementation constraints have been a challenge and have required massive computations to achieve acceptable design quality. Recently, IC design teams have been interested in using elastic computing environments, such as cloud servers, to obtain near-instant access to computing resources. Submitting electronic design automation (EDA) jobs to the cloud servers helps IC design teams to meet the demands of their tapeout schedule, thus reducing the time to market. Launching more cloud servers simultaneously can reduce the turnaround time in running logic synthesis, physical synthesis, and/or simulation tasks for IC design teams, although the cost of using these computing resources may increase. Therefore, submitting electronic design automation (EDA) jobs to the cloud is not a straightforward work, especially for IC design teams with little experience managing elastic computing resources. As a result, estimating and predicting runtimes of EDA jobs before they are submitted to cloud servers are essential for IC designers.

In the prior art, machine learning-based synthesis runtime prediction uses full training data (which can contain outliers) from a database without selecting and filtering data in the pre-process and post-process phases. Therefore, some of the prediction results can be inaccurate and thus may not be suitable to be applied to the real runtime prediction works when designing ICs.

### SUMMARY

An embodiment providing a machine learning-based synthesis runtime prediction method includes collecting initial training data from a database, selecting featured training data from the initial training data useful for predicting runtimes, building a machine learning model for predicting the runtimes based on the featured training data, measuring a loss and an accuracy of the machine learning model, performing standardization and/or normalization on the featured training data of the training data to generate updated training data if the loss and/or the accuracy fails to meet predefined criteria, performing clustering at least once on the updated training data to generate clustered training data, identifying at least one outlier from the clustered training data, removing the at least one outlier to generate filtered training data, and preprocessing, training and testing the machine learning model based on the filtered training data until the loss and the accuracy meet the predefined criteria.

Another embodiment providing machine learning-based synthesis runtime prediction method includes collecting initial training data from a database, selecting featured training data from the initial training data useful for predicting runtimes, building a machine learning model for predicting the runtimes based on the featured training data, measuring a loss and an accuracy of the machine learning model, performing standardization and/or normalization on the featured training data of the training data to generate updated training data if the loss and/or the accuracy fails to meet predefined criteria, performing dimensionality reduction on the updated training data to generate reduced training data, performing clustering at least once on the reduced training data to generate clustered training data, identifying at least one outlier from the clustered training data, removing the at least one outlier to generate filtered training data, and preprocessing, training and testing the machine learning model based on the filtered training data until the loss and the accuracy meet the predefined criteria.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a machine learning-based synthesis runtime prediction method according to an embodiment of the present invention.

FIG. 2 is a flowchart of a method for automatically detecting and removing outliers in FIG. 1 according to an embodiment of the present invention.

### DETAILED DESCRIPTION

In the embodiment, a machine learning-based synthesis runtime prediction method with filtering and selecting training data in a recursive process is proposed to increase the accuracy of runtime prediction.

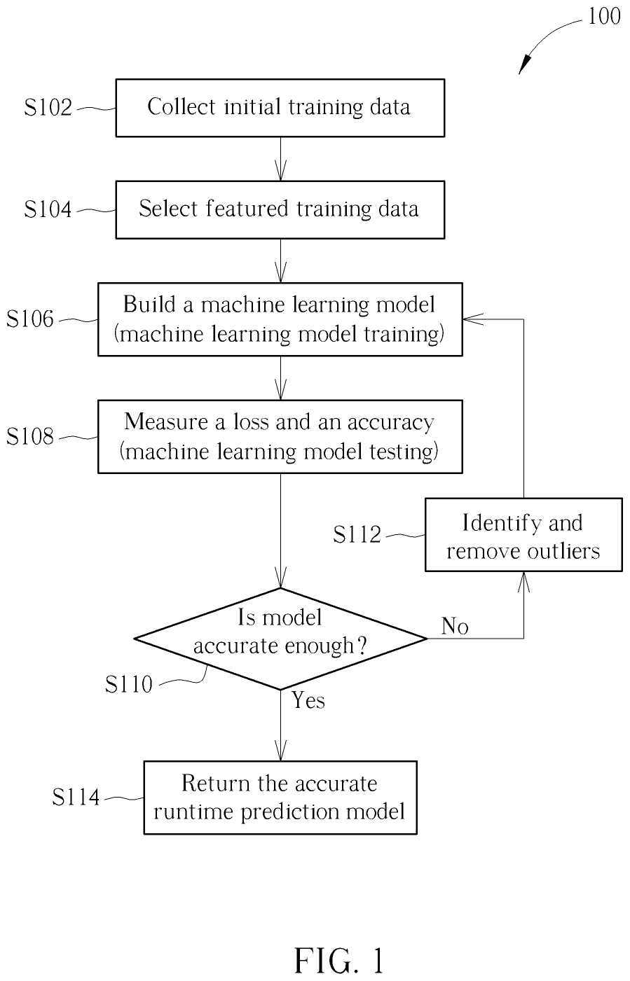

FIG. 1 is a flowchart of a machine learning-based synthesis runtime prediction method 100 according to an embodiment of the present invention.

Step S102: collect initial training data;

Step S104: select featured training data; Step S106: build a machine learning model (machine learning model training);

Step S108: measure a loss and an accuracy (machine learning model testing);

Step S110: is the model accurate enough? If so, go to Step S114; else, go to Step S112.

Step S112: identify and remove outliers to generate filtered training data; go to Step S106;

Step S114: return the accurate runtime prediction model.

In Step S102, the initial training data is collected from a database which contains design data and execution results of electronic design automation (EDA) jobs. In this step, outliers may exist and the filtering preprocess can be applied if needed. In Step S104, the featured training data are selected from the initial training data by selecting only useful features for predicting runtimes. The selection of features can be based on a Pearson correlation coefficient (PCC) analysis. In Step S106, a runtime prediction model is created by training a machine learning model based on the featured training data and the real runtimes. To avoid negative values in the output layer, the machine learning model can be implemented by using log and/or exponential functions. In Step S108, the loss and accuracy of the machine learning model are measured by calculating the differences between the predicted runtimes and respective real runtimes. The metric of accuracy can be a mean square error (MSE) or a root mean square error (RMSE). In Step S110, check the accuracy and loss (MSE or RMSE) of the machine learning model. If the MSE or RMSE is small enough, then go to Step S114 to return a runtime prediction model for practical use. If the model is not accurate enough, then go to Step S112. In Step S112, an automatic process is performed to detect and remove outliers in the featured training data to generate filtered training data. By retraining the machine learning model using the filtered training data, the machine learning model can achieve better accuracy and loss than training the machine learning model by using the featured training data. Therefore, a better accuracy can be measured in Step S108 to meet the requirement in Step S110. If the accuracy of the retrained machine learning model meets the requirement, then perform Step S114. If the accuracy of the retrained machine learning model is not enough, then Step S112 is recursively performed until the machine learning model meets the requirement.

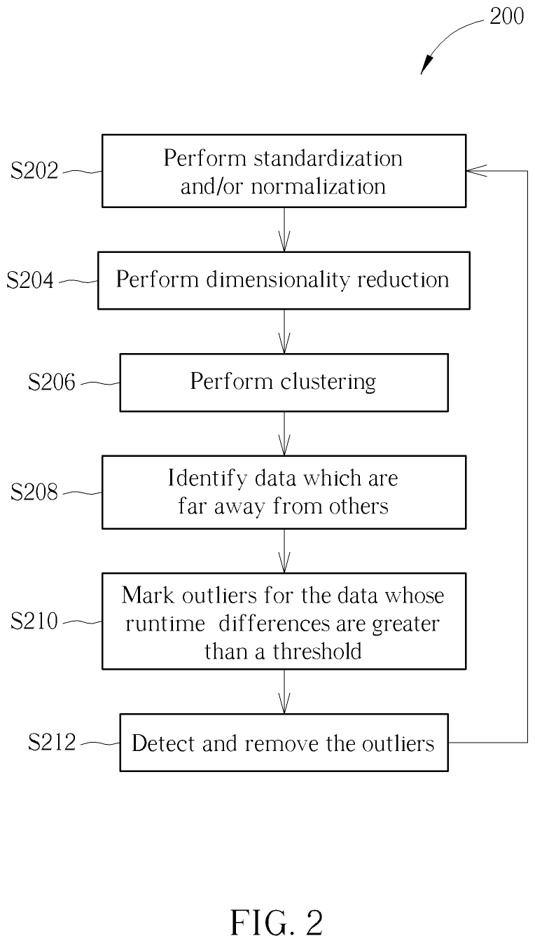

FIG. 2 is a flowchart of a method 200 for automatically detecting and removing outliers in Step S112 of FIG. 1 according to an embodiment of the present invention.

Step S202: perform standardization and/or normalization on the featured training data to generate updated training data;

Step S204: perform dimensionality reduction on the updated training data to generate reduced training data (which are new training data containing a reduced number of features);

Step S206: perform clustering at least once on the reduced training data to generate clustered training data;

Step S208: identify and select data which are far away from the rest of clustered training data from the clustered training data;

Step S210: mark the selected data whose differences between the predicted runtimes and respective real runtimes are greater than a threshold as outliers.

Step S212: detect and remove the outliers to generate the filtered training data.

In Step S202, standardization and/or normalization is performed on the featured training data to generate the updated training data. In an embodiment, the standardization can change the average number of the featured training data to be 0 and the standard deviation number of the featured training data to be 1. The method of standardization is performed to reduce the negative impact of outliers in the featured training data. In another embodiment, the normalization can change the maximum of the featured training data to be 1 and the minimum of the featured training data to be 0. The normalization makes sure that the distances among different data in the featured training data can be measured in the same scale. Therefore, the updated training data is generated for better performance.

In Step S204, dimensionality reduction is performed on the updated training data to generate the reduced training data (which are new training data containing a reduced number of features). This step is optional according to an embodiment in the present invention. If Step S204 is skipped, then Step S206 becomes performing clustering at least once on the updated training data instead of the reduced training data to generate the clustered training data. In one embodiment, dimensionality reduction can be implemented by a principal component analysis (PCA) process. By performing the principal component analysis (PCA) process on the updated training data, the dimensions of the training data can be reduced without losing the major effective features in the updated training data to focus on the essential training data. Therefore, the reduced training data is generated in certain dimensions to reduce the complexity of the updated training data.

In Step S206, clustering is performed at least once on the reduced training data (or the updated training data if Step S204 is skipped) to generate the clustered training data. In an embodiment, the process of clustering can be hierarchical density-based spatial clustering of applications with noise (HDBSCAN), density-based spatial clustering of applications with noise (DBSCAN), k-means clustering, or Gaussian mixtures. By performing clustering, the reduced training data can be classified into several groups and outliers in the clustered training data. This process helps us find outliers which are far away from the groups in the clustered training data. In Step S208, data outside the clustered groups are identified and selected in the clustered training data. That is, data far away from the rest of the clustered training data are identified and selected.

In Step S210, calculate the difference between the real runtime and the predicted runtime of the selected data in Step S208. If the difference is greater than a threshold, then mark the data as outliers. All outliers can be marked in this step using the same process. In Step S212, the detected outliers are removed from the clustered training data to generate the filtered training data. The filtered training data can be used to retrain the machine learning model, thus improving the performance of the prediction of runtimes.

If the loss and accuracy of the machine learning model meet the predefined criteria, then return the model for runtime prediction. If the loss and accuracy of the machine learning model cannot meet the predefined criteria, then redo the process of method 200 by performing Step S202-S212 to obtain better performance until the machine learning model meets the requirement.

In an embodiment, the machine learning model can be an ElasticNet model, an extreme Gradient Boosting (XGBoost) model, a deep neural network (DNN) model or other machine learning models trained based on the featured training data and retrained based on the filtered training data. In an embodiment, the machine learning model can be merged with at least another machine learning model to obtain better performance.

In conclusion, the present invention includes a machine learning-based synthesis runtime prediction method to provide an accurate machine learning model by recursively training the machine learning model without the negative impacts of detected outliers. Compared to prior art, the present invention provides a better accuracy of the machine learning model by applying the process in FIG. 1 and FIG. 2. The better accuracy of predicting runtimes in electronic design automation (EDA) jobs allows submitting electronic design automation (EDA) jobs to the cloud with lower costs, since increasing computing resources for running the submitted jobs may not always reduce the overall turnaround time of designing ICs but its computing costs can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A machine learning-based synthesis runtime prediction method, comprising:
collecting initial training data from a database;
selecting featured training data from the initial training data useful for predicting runtimes;
building a machine learning model for predicting the runtimes based on the featured training data;
measuring a loss and an accuracy of the machine learning model;
performing standardization and/or normalization on the featured training data of the training data to generate updated training data if the loss and/or the accuracy fails to meet predefined criteria;
performing dimensionality reduction on the updated training data to generate reduced training data;
performing clustering at least once on the reduced training data to generate clustered training data;
identifying at least one outlier from the clustered training data;
removing the at least one outlier to generate filtered training data; and
preprocessing, training and testing the machine learning model based on the filtered training data until the loss and the accuracy meet the predefined criteria.

2. The method of claim 1, wherein a piece of the clustered training data is identified as an outlier when a difference between a predicted runtime of the piece of the clustered training data and a real runtime of the piece of the clustered training data is greater than a threshold.

3. The method of claim 1, wherein a piece of the clustered training data is identified as an outlier if the piece of the clustered training data is far away from remaining clustered training data.

4. The method of claim 1, wherein building the machine learning model for predicting the runtimes based on the clustered training data is building an ElasticNet model, an extreme Gradient Boosting (XGBoost) model, or a deep neural network (DNN) model for predicting the runtimes based on the clustered training data.

5. The method of claim 1, wherein selecting the featured training data from the initial training data useful for predicting the runtimes is selecting the featured training data from the initial training data useful for predicting the runtimes based on a Pearson correlation coefficient (PCC) analysis, an XGBoost's feature importance analysis, or other analysis methods.

6. The method of claim 1, wherein building the machine learning model for predicting the runtimes based on the featured training data is building the machine learning model for predicting the runtimes based on the featured training data using a log or exponential function.

7. The method of claim 1, wherein measuring the loss and the accuracy of the machine learning model is measuring the loss and the accuracy of the machine learning model by computing a Pearson correlation coefficient (PCC), a mean square error (MSE), and a root mean square error (RMSE) according to predicted runtimes.

8. The method of claim 1, further comprising merging the machine learning model with at least another machine learning model.

9. The method of claim 1, wherein performing dimensionality reduction on the updated training data to generate the reduced training data is performing a principal component analysis (PCA) on the updated training data to generate the reduced training data.

10. The method of claim 1, wherein performing clustering at least once on the reduced training data to generate the clustered training data is performing hierarchical density-based spatial clustering of applications with noise (HDBSCAN), density-based spatial clustering of applications with noise (DBSCAN), k-means clustering, or Gaussian mixtures at least once on the reduced training data to generate the clustered training data.

11. A machine learning-based synthesis runtime prediction method, comprising:
collecting initial training data from a database;
selecting featured training data from the initial training data useful for predicting runtimes;
building a machine learning model for predicting the runtimes based on the featured training data;
measuring a loss and an accuracy of the machine learning model;
performing standardization and/or normalization on the featured training data of the training data to generate updated training data if the loss and/or the accuracy fails to meet predefined criteria;
performing clustering at least once on the updated training data to generate clustered training data;
identifying at least one outlier from the clustered training data;
removing the at least one outlier to generate filtered training data; and
preprocessing, training and testing the machine learning model based on the filtered training data until the loss and the accuracy meet the predefined criteria.

12. The method of claim 11, wherein a piece of the clustered training data is identified as an outlier when a difference between a predicted runtime of the piece of the clustered training data and a real runtime of the piece of the clustered training data is greater than a threshold.

13. The method of claim 11, wherein a piece of the clustered training data is identified as an outlier if the piece of the clustered training data is far away from remaining clustered training data.

14. The method of claim 11, wherein building the machine learning model for predicting the runtimes based on the clustered training data is building an ElasticNet model, an extreme Gradient Boosting (XGBoost) model, or a deep neural network (DNN) model for predicting the runtimes based on the clustered training data.

15. The method of claim 11, wherein selecting the featured training data from the initial training data useful for predicting the runtimes is selecting the featured training data from the initial training data useful for predicting the runtimes based on a Pearson correlation coefficient (PCC) analysis, an XGBoost's feature importance analysis, or other analysis methods.

16. The method of claim 11, wherein building the machine learning model for predicting the runtimes based on the featured training data is building the machine learning model for predicting the runtimes based on the featured training data using a log or exponential function.

17. The method of claim 11, wherein measuring the loss and the accuracy of the machine learning model is measuring the loss and the accuracy of the machine learning model by computing a Pearson correlation coefficient (PCC), a mean square error (MSE), and a root mean square error (RMSE) according to predicted runtimes.

18. The method of claim 11, further comprising merging the machine learning model with at least another machine learning model.

19. The method of claim 11, wherein performing clustering at least once on the reduced training data to generate the clustered training data is performing hierarchical density-based spatial clustering of applications with noise (HDBSCAN), density-based spatial clustering of applications with noise (DBSCAN), k-means clustering, or Gaussian mixtures at least once on the reduced training data to generate the clustered training data.
